(19) United States
(12) Patent Application Publication
(10) Pub. No.: US 2026/0343372 A1
(43) Pub. Date: Oct. 29, 2026

(54) DATA FORWARDING FOR DUAL CONNECTIVITY

(71) Applicant: Nokia Technologies Oy, Espoo (FI)

(72) Inventors: Panagiotis SPAPIS, Munich (DE); Ahmad AWADA, Munich (DE); Umur KARABULUT, Munich (DE); Halit Murat GÜRSU, Munich (DE); Krzysztof KORDYBACH, KORDYBACH (PL); Ayaz AHMED, Bangalore (IN)

(21) Appl. No.: 19/101,566

(22) PCT Filed: Jun. 15, 2023
(86) PCT No.: PCT/EP2023/066046

§ 371 Date: Feb. 5, 2025

(30) Foreign Application Priority Data
Aug. 5, 2022 (IN) 202241044886

(51) Int. Cl. H04W 36/36; H04W 36/00

(52) U.S. Cl. CPC H04W 36/362; H04W 36/0058; H04W 36/0069

(57) ABSTRACT

The present subject matter relates to a method comprising: sending by an apparatus to a user equipment a message, herein referred to as reconfiguration message, for a conditional handover, the reconfiguration message indicating a set of one or more candidate target master nodes and associated candidate target secondary nodes; in response to the sending of the reconfiguration message, receiving by the apparatus from the user equipment a message indicating at least one specific candidate target secondary node of the candidate target secondary nodes; performing by the apparatus data forwarding to the at least one specific candidate target secondary node and to a subset of the candidate target master nodes that are associated with the at least one the specific candidate target secondary node.

### TECHNICAL FIELD

Various example embodiments relate to telecommunication systems, and more particularly to data forwarding for enabling handover and secondary cell change.

### BACKGROUND

The fifth generation wireless networks (5G) refer to a new generation of radio systems and network architecture. 5G is expected to provide higher bitrates and coverage than the current long term evolution (LTE) systems. 5G is also expected to increase network expandability up to hundreds of thousands of connections. However, there is a need to improve the communication services provided at these systems in particular for enabling the dual connectivity. Some aspects of dual connectivity have been described in standards, such as TS 36.300, TS 36.423, TS 36.413 for LTE, or TS38.300, TS 37.340, TS 38.423 for NR, and/or the like.

### SUMMARY

Example embodiments provide an apparatus being configured as a master node in order to serve a user equipment in dual connectivity. The apparatus comprises means. The means are configured for: sending to the user equipment a message, herein referred to as reconfiguration message, for a conditional handover, the reconfiguration message indicating a set of one or more candidate target master nodes and associated candidate target secondary nodes; in response to the sending of the reconfiguration message, receiving from the user equipment a message indicating at least one specific candidate target secondary node of the candidate target secondary nodes; performing data forwarding to the at least one specific candidate target secondary node and to a subset of the candidate target master nodes that are associated with the at least one specific candidate target secondary node.

Example embodiments provide a user equipment being in dual connectivity with an apparatus, acting as a source master node, and a source secondary node. The user equipment comprises means. The means are configured for: receiving, from the apparatus, a reconfiguration message for a conditional handover, the reconfiguration message indicating a condition, herein referred to as CHO condition, for a conditional handover, CHO, to a set of candidate target master nodes and another condition, herein referred to as CPC condition, for a conditional Primary secondary cell Change (CPC) to candidate target secondary nodes; evaluating the CHO condition and the CPC condition; in response to determining that the CPC condition is fulfilled by a at least one specific candidate target secondary node of the candidate target secondary nodes, sending a message to the apparatus indicating the at least one specific candidate target secondary node.

Example embodiments provide a method. The method comprises: sending by an apparatus to a user equipment a message, herein referred to as reconfiguration message, for a conditional handover, the reconfiguration message indicating a set of one or more candidate target master nodes and associated candidate target secondary nodes; in response to the sending of the reconfiguration message, receiving by the apparatus from the user equipment a message indicating at least one specific candidate target secondary node of the candidate target secondary nodes; performing by the apparatus data forwarding to the at least one specific candidate target secondary node and to a subset of the candidate target master nodes that are associated with the at least one specific candidate target secondary node.

Example embodiments provide a computer program comprising instructions for causing an apparatus for performing at least the following: sending to a user equipment a message, herein referred to as reconfiguration message, for a conditional handover, the reconfiguration message indicating a set of one or more candidate target master nodes and associated candidate target secondary nodes; in response to the sending of the reconfiguration message, receiving from the user equipment a message indicating at least one specific candidate target secondary node of the candidate target secondary nodes; performing data forwarding to the at least one specific candidate target secondary node and to a subset of the candidate target master nodes that are associated with the at least one specific candidate target secondary node.

Example embodiments provide a method. The method comprises: receiving, from an apparatus, a reconfiguration message for a conditional handover, the reconfiguration message indicating a condition, herein referred to as CHO condition, for a conditional handover to a set of candidate target master nodes and another condition, herein referred to as CPC condition, for a conditional Primary secondary cell Change (CPC) to one or more candidate target secondary nodes; evaluating the CHO condition and the CPC condition; in response to determining that the CPC condition is fulfilled by a at least one specific candidate target secondary node of the candidate target secondary nodes, sending a message to the apparatus indicating the at least one specific candidate target secondary node.

Example embodiments provide a computer program comprising instructions for causing a user equipment for performing at least the following: receiving, from an apparatus, a reconfiguration message for a conditional handover, the reconfiguration message indicating a condition, herein referred to as CHO condition, for a conditional handover to a set of candidate target master nodes and another condition, herein referred to as CPC condition, for a conditional Primary secondary cell Change (CPC) to one or more candidate target secondary nodes; evaluating the CHO condition and the CPC condition; in response to determining that the CPC condition is fulfilled by a at least one specific candidate target secondary node of the candidate target secondary nodes, sending a message to the apparatus indicating the at least one specific candidate target secondary node.

In one example, the at least one specific candidate target secondary node that fulfills the CPC condition may be one specific candidate target secondary node.

### BRIEF DESCRIPTION OF THE DRAWINGS

The accompanying figures are included to provide a further understanding of examples, and are incorporated in and constitute part of this specification. In the figures:

FIG. 1 illustrates a part of an exemplifying radio access network;

FIG. 2 is a schematic illustration of a wireless communication system;

FIG. 3 is a flowchart of a method used in a master node according to an example of the present subject matter;

FIG. 4 is a flowchart of a method used in a user equipment according to an example of the present subject matter;

FIG. 5 is a flowchart of a method used in a master node according to an example of the present subject matter;

FIG. 6 is a flowchart of a method used in a user equipment according to an example of the present subject matter;

FIG. 7 is a flow diagram of a signaling method for a conditional handover in accordance with an example of the present subject matter;

FIG. 8 is a flow diagram of a signaling method for a conditional handover in accordance with an example of the present subject matter;

FIG. 9A is a diagram illustrating a process of monitoring the CPC and CHO conditions by a user equipment in accordance with an example of the present subject matter;

FIG. 9B is a diagram illustrating a process of monitoring the CPC and CHO conditions by a user equipment in accordance with an example of the present subject matter;

FIG. 9C is a diagram illustrating a process of monitoring the CPC and CHO conditions by a user equipment in accordance with an example of the present subject matter;

FIG. 10 is a block diagram showing an example of an apparatus according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

A communication system may be provided. The communication system comprises nodes such as base stations, wherein each node may serve user equipments (UEs) located within the node's geographical area of service or a cell. The communication system may support one or more radio access technologies (RATs). A radio access technology of the radio access technologies may, for example, be evolved universal terrestrial radio access (E-UTRA) or 5G new radio (NR), but it is not limited to, as a person skilled in the art may apply the present subject matter to other communication systems provided with necessary properties.

The communication system may enable dual connectivity. During dual connectivity operation, a user equipment may couple to a first node and further couple to a second node. The dual connectivity may thus involve a user equipment and two nodes. One node of the two nodes may act as a master node (MN) and the other node may act as a secondary node (SN). The master node and secondary node may be connected via a network interface and at least the master node is connected to a core network of the communication system. The nodes of the communication system may comprise a plurality of nodes which are configured to operate as master nodes and a plurality of nodes which are configured to operate as secondary nodes during a dual connectivity operation. Communication between two nodes of the communication system may be through an ideal backhaul or non-ideal backhaul. Dual connectivity may allow the user equipment to consume radio resources provided by the two nodes. In particular, the dual connectivity may allow the user equipment to communicate with the two nodes simultaneously by sending to and receiving data from the two nodes in two totally separate streams.

The geographical area of service of the master node may be referred to as primary cell. The geographical area of service of the secondary node may be referred to as primary secondary cell. In one example, the two nodes and the user equipment may communicate with one another via multiple component carriers. For example, the master node may communicate with the user equipment via a first set of component carriers providing coverage over a first set of cells forming a so-called master cell group (MCG). The secondary node may communicate with the user equipment via a second set of component carriers providing coverage over a second set of cells forming a so-called secondary cell group (SCG). The cell of the first set of cells that is used to initiate initial access may be called a primary cell (PCell) and the remaining cells may be named secondary cells (SCells). Similarly, the second set of cells comprises a primary cell (PSCell) which can be understood as a cell for which initial access is initiated under the SCG and secondary cells (SCells).

The nodes of the communication system may comprise low-power nodes and high-power nodes. The low-power node may be configured to transmit with lower power and with fewer processing/hardware capacities than the high-power node. The low-power node may comprise a small base station, micro, or pico, or femto base station. The low-power nodes may enable to cope with mobile traffic explosion, especially for hotspot deployments in indoor and outdoor scenarios. The master node may, for example, be a high-power node. The secondary node may, for example, be a high-power node or low power node.

The present subject matter may improve the dual connectivity operation for enhancing mobility robustness in the communication system. For that, an apparatus may be provided. The apparatus may be configured as a master node in a dual connectivity involving a user equipment and a secondary node. The apparatus may be configured as the master node after the dual connectivity has been established. The user equipment may be referred to herein as dual connectivity user equipment and the secondary node may be referred to as serving secondary node. The dual connectivity user equipment may be served by the apparatus in a primary cell such as PCell. The dual connectivity user equipment may be served by the serving secondary node in a primary secondary cell e.g., such as PSCeII.

The movement of the dual connectivity user equipment may trigger the handover of the dual connectivity user equipment from the primary cell to a target primary cell served by a target master node. This handover, if done in conditional manner, is referred to as conditional handover (CHO). The movement of the dual connectivity user equipment may trigger a change of the primary secondary cell to a target primary secondary cell served by a target secondary node. This primary secondary cell change, if done in conditional manner, may be referred to as a Conditional Primary secondary cell (PSCeII) Change (CPC).

The dual connectivity user equipment may be configured to perform cell measurement in connected mode, inactive mode or idle mode, of the primary cell. Measuring a cell such as the primary cell may, for example, be performed by measuring (e.g., a power of) at least one beam of the cell. The beam measurement results may be combined (e.g., averaged) to derive a signal quality or cell quality of the cell. The signal quality may, for example, be a reference signal received power (RSRP) or reference signal received quality (RSRQ) measurement. The cell measurements may advantageously be used in order to perform a conditional handover (CHO) procedure. For example, the dual connectivity user equipment may be configured to check whether an initial handover criterion is fulfilled or satisfied using the cell measurements of the primary cell. The initial handover criterion may, for example, comprise conditions of a radio resource management (RRM) event A3. The fulfillment of the initial handover condition may trigger the dual connectivity user equipment to send a measurement report to the apparatus. Based on the measurement report, the apparatus may determine if the handover is required or not, and if required the apparatus may select a set of M candidate target master nodes

$${T}_{MN}^{cand \_ 1} , … , {T}_{MN}^{cand \_ M}$$

e.g. among a neighbour list of target master nodes, where M≥1. The apparatus may prepare the set of M candidate target master nodes

$${T}_{MN}^{cand \_ 1} , … , {T}_{MN}^{cand \_ M}$$

for the conditional handover of the dual connectivity user equipment to one candidate target master node of the set of candidate target master nodes

$${T}_{MN}^{cand \_ 1} , … , {T}_{MN}^{cand \_ M} .$$

Alternatively, the apparatus may automatically prepare the set of candidate target master nodes

$${T}_{MN}^{cand \_ 1} , … , {T}_{MN}^{cand \_ M}$$

for the conditional handover of the dual connectivity user equipment to one node of the set of candidate target master nodes

$${T}_{MN}^{cand \_ 1} , … , {T}_{MN}^{cand \_ M}$$

e.g., without relying on the measurement report. The preparation of the set of candidate target master nodes may comprise sending by the apparatus a handover request to the set of candidate target master nodes

$${T}_{MN}^{cand \_ 1} , … , {T}_{MN}^{cand \_ M} .$$

In response, each i^{th} (where i is a number between 1 and M) candidate target master node

$${T}_{MN}^{cand \_i}$$

of the set of candidate target master nodes

$${T}_{MN}^{cand \_ 1} , … , {T}_{MN}^{cand \_ M}$$

may send a handover request acknowledgment to the apparatus, wherein the handover request acknowledgment indicates the candidate target secondary nodes associated with the candidate target master node

$${T}_{MN}^{cand \_ i} .$$

For example, each handover request acknowledgment may comprise Tunnel Endpoint Identifiers (TEIDs) of direct tunnels (e.g., a data radio bearer (DRB) tunnels) that may be established by the apparatus to the candidate target master node

$${T}_{MN}^{cand \_ i}$$

and associated candidate target secondary nodes. Thus, each candidate target secondary node

$${T}_{SN}^{cand \_ j} ,$$

where j can be any number between 1 and N the number of candidate target secondary nodes, is associated with a subset of nⱼ≥1 candidate target master nodes

$$\{ {T}_{MN}^{cand \_ i} , i ∈ {K}_{j} \} ,$$

where Kⱼ is the list of indices representing the nⱼ candidate target master nodes. The candidate target secondary node

$${T}_{SN}^{cand \_ j}$$

is associated with the subset of nⱼ≥1 candidate target master nodes

$$\{ {T}_{MN}^{cand \_ i} , i ∈ {K}_{j} \} ,$$

means that the primary secondary cell served by the candidate target secondary node

$${T}_{SN}^{cand \_ j}$$

overlaps at least partially with each primary cell served by the subset of nⱼ≥1 candidate target master nodes

$$\{ {T}_{MN}^{cand \_ i} , i ∈ {K}_{j} \} .$$

After preparing the set of candidate target master nodes

$${T}_{MN}^{cand \_ 1} , … , {T}_{MN}^{cand \_ M} ,$$

the apparatus may send a message (named herein as a reconfiguration message) to the dual connectivity user equipment for the conditional handover to one candidate target master node of the set of candidate target master nodes

$${T}_{MN}^{cand \_ 1} , … , {T}_{MN}^{cand \_ M}$$

and for the primary secondary cell change to one candidate target secondary node of a set of N candidate target secondary nodes

$${T}_{SN}^{cand \_ 1} , … , {T}_{SN}^{cand \_ N} ,$$

where N≥M. Each candidate target master node of the set of candidate target master nodes

$${T}_{MN}^{cand \_ 1} , … , {T}_{MN}^{cand \_ M}$$

may be associated with one or more candidate target secondary nodes of the set of candidate target secondary nodes

$${T}_{SN}^{cand \_ 1} , … , {T}_{SN}^{cand \_ N}$$

for enabling the dual connectivity operation. The reconfiguration message may be provided by means of dedicated signalling e.g., using the radio resource control (RRC) Reconfiguration.

The reconfiguration message may comprise first information indicative of a condition (named herein as a CHO condition) for the conditional handover to each candidate target master node of the set of candidate target master nodes

$${T}_{MN}^{cand \_ 1} , … , {T}_{MN}^{cand \_ M}$$

and the configuration (CHO command) that the dual connectivity user equipment shall apply for the candidate target master node when its corresponding CHO condition is fulfilled. The reconfiguration message may further comprise second information indicative of another condition (named herein as a CPC condition) for the CPC to each node of the candidate target secondary nodes

$${T}_{SN}^{cand \_ 1} , … , {T}_{SN}^{cand \_ N}$$

and configuration to be applied on the candidate target secondary node that satisfies the CPC condition.

Upon receiving the reconfiguration message, the dual connectivity user equipment may determine whether the CHO condition is satisfied and whether the CPC condition is satisfied e.g., using the cell measurements of the primary cells and the cell measurements of primary secondary cells. Alternatively, the dual connectivity user equipment may be configured to automatically check the CHO condition and the CPC condition without relying on the reconfiguration message. In other words, triggering the dual connectivity user equipment with the reconfiguration message to check the CHO condition and the CPC condition may be optional. The dual connectivity user equipment may repeatedly check the CPC condition and the CHO condition.

The CPC condition may require that a signal value indicative of a signal received from a candidate target secondary node exceeds another signal value indicative of a signal received from the serving secondary node by at least an offset value for a time-to-trigger (TTT) interval. The CPC condition may be checked, by the dual connectivity user equipment, separately for each candidate target secondary node of the candidate target secondary nodes

$${T}_{SN}^{cand \_ 1} , … , {T}_{SN}^{cand \_ N} .$$

The CHO condition may require that a signal value indicative of a signal received from a candidate target master node exceeds another signal value indicative of a signal received from the apparatus by at least an offset value for TTT interval. Each value of the signal values may be a RSRP or RSRQ. The CHO condition may be checked, by the user equipment, separately for each candidate target master node of the set of candidate target master nodes

$${T}_{MN}^{cand \_ 1} , … , {T}_{MN}^{cand \_ M} .$$

At least one candidate target secondary node may satisfy the CPC condition. In one example, one candidate target secondary node may satisfy the CPC condition. If one j^{th} candidate target secondary node

$${T}_{SN}^{cand \_ j}$$

satisfies the CPC condition before the CHO condition is satisfied, the dual connectivity user equipment may send a message (named CPC message) to the apparatus indicating said candidate target secondary node

$${T}_{SN}^{cand \_ j} .$$

In one example, the CPC message may further comprise CHO measurements performed by the dual connectivity user equipment. The CHO measurements may comprise cell measurements of cells served by the set of candidate target master nodes

$${T}_{MN}^{cand \_ 1} , … , {T}_{MN}^{cand \_ M} .$$

In response to receiving the CPC message, the apparatus may start data forwarding to the candidate target secondary node

$${T}_{SN}^{cand \_ j}$$

and and to the subset of candidate target nodes

$$\{ {T}_{MN}^{cand \_ i} , i ∈ {K}_{j} \}$$

associated with the candidate target secondary node

$${T}_{SN}^{cand \_ j} .$$

Alternatively, the apparatus may use the CHO measurements to select a sub-subset of the subset of candidate target nodes

$$\{ {T}_{MN}^{cand \_ i} , i ∈ {K}_{j} \}$$

toward which the dual connectivity user equipment is most likely moving. For example, the CHO measurements may be used by the apparatus to predict a movement path of the dual connectivity user equipment, wherein the selected sub-subset of the subset of candidate target nodes may be serving cells closely located to the movement path. The data forwarding may thus be performed to the candidate target secondary node

$${T}_{SN}^{cand \_ j}$$

and to the selected sub-subset of candidate target master nodes. The data forwarding concerns data of the dual connectivity user equipment, that is, the data forwarding is performed for packets that may be used by the target node(s) to continue serving the dual connectivity user equipment. The present subject matter may thus optimize the data forwarding as it may be performed on time and only relevant nodes may receive forwarded data. The present subject matter may enable the data forwarding in CHO with candidate SCGs for Conditional PSCell Change/Addition (CPAC).

The data forwarding comprises delivering buffered packets to the candidate target secondary node

$${T}_{SN}^{cand \_ j}$$

and to the subset of candidate target master nodes

$$\{ {T}_{MN}^{cand \_ i} , i ∈ {K}_{j} \}$$

associated with the candidate target secondary node

$${T}_{SN}^{cand \_ j} .$$

The data forwarding may further comprise delivering in-transit packets. The in-transit packets may be packets that should be sent to the target node that satisfied the CHO/CPC condition but sent to the apparatus for transit after handover and before completion of the path switch to the candidate target master node that satisfied the CHO condition. Moreover, the apparatus may send to the subset of candidate target master nodes

$$\{ {T}_{MN}^{cand \_ i} , i ∈ {K}_{j} \}$$

a sequence number status transfer message indicating the next missing packets in downlink and uplink.

If after the CPC condition is satisfied, the CHO condition is satisfied by a specific candidate target master node, the dual connectivity user equipment may stop exchange of data with the apparatus and synchronise to the specific candidate target master node. The dual connectivity user equipment may detach from the apparatus and apply a configuration to the specific candidate target master node before synchronizing to the specific candidate target master node. The dual connectivity user equipment may further synchronize to the candidate target secondary node

$${T}_{SN}^{cand \_ j} .$$

If, for example, the CPC condition has been fulfilled by multiple candidate target secondary nodes, the synchronization may be performed with the candidate target secondary node that is associated with the specific candidate target master node. If multiple candidate target secondary nodes satisfy the CPC condition and are associated with the specific candidate target master node, one candidate target secondary node of the multiple candidate target secondary nodes may be selected e.g., the selected one may have the highest received signal at the dual connectivity user equipment or the selected one may be randomly selected, wherein the synchronization may be performed to the selected candidate target secondary node. The dual connectivity user equipment may apply a configuration to the the candidate target secondary node

$${T}_{SN}^{cand \_ j}$$

before synchronizing to the candidate target secondary node

$${T}_{SN}^{cand \_ j} .$$

The dual connectivity user equipment may synchronize to the specific candidate target master node and to the specific candidate target secondary node using a synchronization procedure. The synchronization procedure may, for example, be a random-access procedure (RACH) of LTE or 5G NR system. After synchronization, the dual connectivity user equipment may be in dual connectivity with the specific candidate target master node and the candidate target secondary node

$${T}_{SN}^{cand \_ j} .$$

The dual connectivity user equipment may perform the synchronization to the specific candidate target secondary node

$${T}_{SN}^{cand \_ j}$$

before or after synchronizing to the specific candidate target master node.

The specific candidate target master node may be part of the subset of nⱼ candidate target master nodes

$$\{ {T}_{MN}^{cand \_ i} , i ∈ {K}_{j} \}$$

associated with the candidate target secondary node

$${T}_{SN}^{cand \_ j}$$

that satisfied the GPO condition. However, if the specific candidate target master node is not part of the subset of nⱼ candidate target master nodes

$$\{ {T}_{MN}^{cand \_ i} , i ∈ {K}_{j} \} ,$$

the dual connectivity user equipment may further continue the monitoring of the CPC and CHO conditions.

The present subject matter may enable date forwarding process which is faster than the so-called late data forwarding. If so-called early data forwarding is not mandatory, the present subject matter may achieve low interruption time with low data forwarding overhead. The present subject matter may, thus, enable an uninterrupted availability and high reliability of communications between devices and the base stations of the communication system. This may fulfil ultra-reliable and low-latency communications (URLLC) requirement during user equipment handover procedures.

According to one example, the apparatus may receive from the dual connectivity user equipment a message indicating that the candidate target secondary node

$${T}_{SN}^{cand \_ j}$$

satisfies a leaving condition. The dual connectivity user equipment may use the connection to the apparatus to send the message in order to inform it about the fact that the leaving condition is satisfied by the the candidate target secondary node

$${T}_{SN}^{cand \_ j} .$$

Upon receiving that message, the apparatus may stop the data forwarding to the candidate target secondary node

$${T}_{SN}^{cand \_ j}$$

and to the subset of candidate target nodes

$$\{ {T}_{MN}^{cand \_ i} , i ∈ {K}_{j} \}$$

associated with the candidate target secondary node

$${T}_{SN}^{cand \_ j}$$

This may be advantageous in case the dual connectivity user equipment moves to a primary secondary cell served by another candidate target secondary node.

In one example, the dual connectivity user equipment may send the message indicating that the candidate target secondary node

$${T}_{SN}^{cand \_ j}$$

satisfies the leaving condition if the CHO condition is not satisfied yet. For example, after the CPC condition is fulfilled by the candidate target secondary node

$${T}_{SN}^{cand \_ j} ,$$

the dual connectivity user equipment may repeatedly evaluate a CPC leaving condition. The CPC leaving condition may, for example, be defined as the opposite of the CPC condition, e.g., after the CPC condition is fulfilled, the dual connectivity user equipment may continue checking whether each candidate target secondary node of the candidate target secondary nodes satisfies the CPC condition, and if the CP condition is not anymore satisfied by the candidate target secondary node

$${T}_{SN}^{cand \_ j}$$

the dual connectivity user equipment may determine that the CPC leaving condition is fulfilled. Alternatively, the CPC leaving condition may be defined independently of the CPC condition, e.g., the reconfiguration information received by the dual connectivity user equipment may further indicate the CPC leaving condition. In this case, the dual connectivity user equipment may repeatedly check whether only the candidate target secondary node

$${T}_{SN}^{cand \_ j}$$

satisfies the CPC leaving condition.

If multiple candidate target secondary nodes satisfy the CPC condition, the CPC leaving condition may be checked for the multiple candidate target secondary nodes. If the CPC leaving condition is satisfied by the multiple candidate target secondary nodes, the apparatus may stop the data forwarding to the multiple candidate target secondary node and all associated subset of candidate target nodes. If the CPC leaving condition is only satisfied by part of the multiple candidate target secondary nodes, the apparatus may stop the data forwarding to that part of candidate target secondary nodes and associated candidate target master nodes and continue data forwarding to the other part of candidate target secondary nodes and associated candidate target master nodes.

In one example, upon receiving by the apparatus a handover success message from the specific candidate target master node, the apparatus may stop the data forwarding to the candidate target master nodes of the subset of candidate target master nodes which are different from the specific candidate target master node. In addition, the apparatus may stop the data forwarding to the specific candidate target master node if the path switch to the specific candidate target master node is completed.

For example, an apparatus APP is provided. The apparatus APP comprises: at least one processor; and at least one memory including computer program code, where the at least one memory and the computer program code are configured, with the at least one processor, to cause the apparatus for: sending to the user equipment UE1 a message, herein referred to as reconfiguration message, for a conditional handover, the reconfiguration message indicating a set of one or more candidate target master nodes and associated candidate target secondary nodes; in response to the sending of the reconfiguration message, receiving from the user equipment a message indicating a specific candidate target secondary node of the candidate target secondary nodes; performing data forwarding to the specific candidate target secondary node and to a subset of the candidate target master nodes that are associated with the specific candidate target secondary node. In one example, the apparatus APP may be serving the user equipment UE1 during a dual connectivity operation of the user equipment UE1. The user equipment UE1 may be connected with the apparatus APP. The user equipment UE1 may further be connected with a secondary node during the dual connectivity operation.

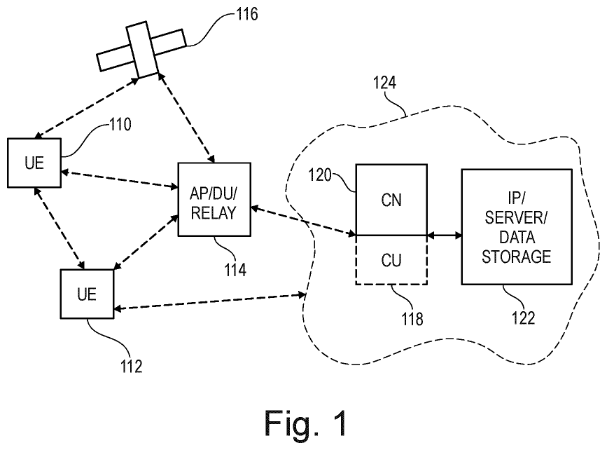

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 110 and 112. The devices 110 and 112 may, for example, be user devices. The devices 110 and 112 are configured to be in a wireless connection on one or more communication channels with a node 114. The node 114 is further connected to a core network 120. In one example, the node 114 may be an access node (such as (e/g)NodeB) 114 providing or serving devices in a cell. In one example, the node 114 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 20 (CN or next generation core NGC). For example, the (e/g)NodeB may connect to an access and mobility management function (AMF) and user plane function (UPF) in the control plane and user plane, respectively. Depending on the system, the counterpart on the CN side can be a serving gateway (S-GW, routing and forwarding user data packets), packet data network gateway (P-GW), for providing connectivity of devices (UEs) to external packet data networks, or mobile management entity (MME), etc.

The device (also called user device, UE, user equipment, user terminal, terminal device, etc.) illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station.

The device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilize cloud. In some applications, a device may comprise a user portable device with radio parts (such as a watch, earphones or eyeglasses) and the computation is carried out in the cloud. The device (or in some embodiments a layer 3 relay node) is configured to perform one or more of user equipment functionalities. The device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities).

CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented. 5G enables using multiple input—multiple output (MIMO) antennas, many more base stations or nodes than an existing LTE system (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet as illustrated by the component referenced by reference numeral 122, or utilize services provided by them. The communication network may also be able to support the usage of cloud services, for example at least part of core network operations may be carried out as a cloud service (this is depicted in FIG. 1 by “cloud” 124). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN).

Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 114) and non-real time functions being carried out in a centralized manner (in a centralized unit, CU 118).

It should also be understood that the distribution of labour between core network operations and base station operations may differ from that of the LTE or even be non-existent. Some other technology advancements probably to be used are Big Data and all-IP, which may change the way networks are being constructed and managed. 5G is being designed to support multiple hierarchies, where MEC servers can be placed between the core and the base station or nodeB (gNB). It should be appreciated that MEC can be applied in 4G networks as well. 5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 116 in the mega-constellation may cover several satellite-enabled network entities that create on-ground cells. The on-ground cells may be created via an on-ground relay node 114 or by a gNB located on-ground or in a satellite.

It is understandable for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. One of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

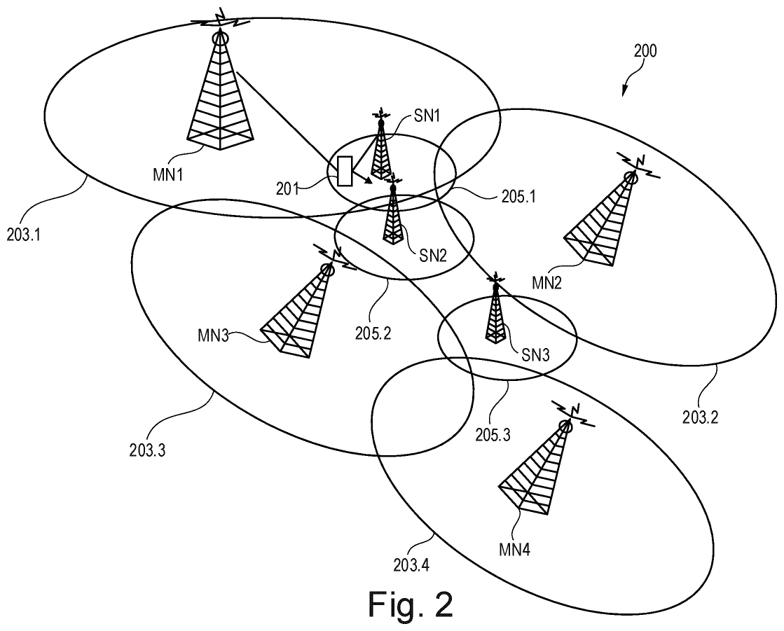

FIG. 2 is a schematic illustration of a wireless communication system 200. The communication system 200 may be configured to use a time division duplex (TDD) technique for data transmission.

For simplicity, communication system 200 is shown to include four master nodes MN1, MN2, MN3 and MN4, three secondary nodes SN1, SN2 and SN3 and a user equipment 201. Each node of the master nodes MN1 to MN4 and secondary nodes SN1 to SN3 may, for example, be eNodeB or gNB e.g., as described with reference to FIG. 1. That is, the communication system 200 may support a same RAT or different RATs.

Each node of the master nodes MN1 to MN4 may serve UEs within a respective geographical coverage area of service or cell 203.1-4. Each node of the secondary nodes SN1 to SN3 may serve UEs within a respective geographical coverage area of service or cell 205.1-3.

In this particular example, the master node MN1 is associated with the secondary nodes SN1 and SN2. That is, the master node MN1 may be configured in dual connectivity with the secondary node SN1 and a user equipment such as the UE 201.

Or, the master node MN1 may be configured in dual connectivity with the secondary node SN2 and a user equipment such as the UE 201. The master node MN2 is associated with the secondary nodes SN1, SN2 and SN3. The master node MN3 is associated with the secondary nodes SN2 and SN3. The master node MN4 is associated with the secondary node SN3.

In this particular example, the UE 201 is moving e.g., from the left to the right. Initially, the UE 201 is in dual connectivity with the master node MN1 and the secondary node SN1. Accordingly, the master node MN1 may be referred to as the source master node MN1 and the secondary node SN1 may be referred to as the source secondary node SN1.

While the user equipment 201 is moving from the left to the right, it is configured to perform neighbor cell measurements for cells 203.2-3 and 205.2-3.

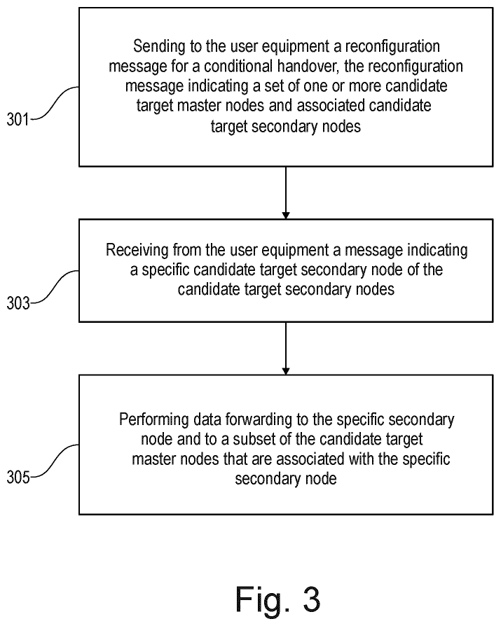

FIG. 3 is a flowchart of a method according to an example of the present subject matter.

For the purpose of explanation, the method described in FIG. 3 may be implemented in the system illustrated in FIG. 2, but is not limited to this implementation. The method may, for example, be performed by the source master node MN1.

The method starts at step 301, where the source master node MN1 may send to the user equipment 201 a reconfiguration message for a conditional handover. The reconfiguration message indicates a set of one or more candidate target master nodes and associated candidate target secondary nodes. Following the example of FIG. 2, the reconfiguration message indicates the set of candidate target master nodes MN2, MN3 and MN4 and the associated candidate target secondary nodes SN2 and SN3.

For example, the source master node MN1 may select the master nodes MN2, MN3 and MN4 as candidate target master nodes for the moving user equipment 201 e.g., because they are neighboring nodes of the source master node MN1. For example, the reconfiguration message may comprise a data structure comprising the following pair entries {MN2, SN2}, {MN2, SN3}, {MN3, SN2} {MN3, SN3} and {MN4, SN3} of the candidate target master nodes and associated candidate target secondary nodes. The reconfiguration message may further comprise a CPC configuration and CHO configuration. The CPC configuration may indicate the CPC condition that may be checked by the UE 201 and the configuration to be applied to a target secondary node that satisfied the CPC condition. The CPC configuration may further indicate the CPC leaving condition. The CHO configuration may indicate the CHO condition that may be checked by the UE 201 and the configuration to be applied to a target master node that satisfies the CHO condition.

In response to the sending of the reconfiguration message, the source master node MN1 may receive in step 303 from the user equipment 201 a message (named CPC message) indicating a candidate target secondary node of the candidate target secondary nodes SN2 and SN3. Assuming, for example, that the candidate target secondary node SN2 is indicated in the CPC message, meaning that the target secondary node SN2 fulfilled the CPC condition.

Upon receiving the CPC message, the method proceeds to step 305, where the source master node MN1 may perform data forwarding to the candidate target secondary node SN2 and to a subset of the candidate primary target nodes that are associated with the candidate target secondary node SN2. For example, the source master node MN1 may select using the received data structure the entries comprising the candidate target secondary node SN2. This may result in the following selected entries: {MN2, SN2} and {MN3, SN2}. The subset of the candidate primary target nodes may thus comprise the master nodes MN2 and MN3 as indicated in the selected entries. The data forwarding performed by the apparatus may concern data that enables to service the user equipment 201.

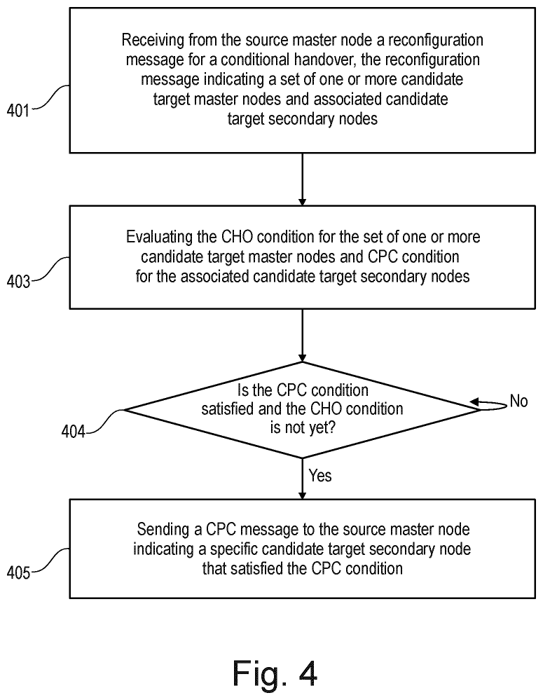

FIG. 4 is a flowchart of a method used in a user equipment according to an example of the present subject matter. For the purpose of explanation, the method described in FIG. 4 may be implemented in the system illustrated in FIG. 2, but is not limited to this implementation. The method may, for example, be performed by the user equipment 201.

The method starts at step 401, where the user equipment 201 may receive from the source master node MN1 a reconfiguration message for a conditional handover. The reconfiguration message indicates a set of one or more candidate target master nodes and associated candidate target secondary nodes. Following the example of FIG. 2, the reconfiguration message indicates the set of candidate target master nodes MN2, MN3 and MN4 and the associated candidate target secondary nodes SN2 and SN3.

For example, the reconfiguration message may comprise a data structure comprising the following pair entries: {MN2, SN2}, {MN2, SN3}, {MN3, SN2} {MN3, SN3} and {MN4, SN3} of the candidate target master nodes and associated candidate target secondary nodes. The reconfiguration message may further comprise a CPC configuration and CHO configuration. The CPC configuration may indicate the CPC condition that may be checked by the UE 201 and the configuration to be applied to a target secondary node that satisfied the CPC condition. The CPC configuration may further indicate the CPC leaving condition. The CHO configuration may indicate the CHO condition that may be checked by the UE 201 and the configuration to be applied to a target master node that satisfied the CHO condition.

Upon receiving the reconfiguration message, the user equipment 201 may check in step 403 the CHO condition and the CPC condition. The user equipment 201 may check whether the CPC condition is fulfilled by any one of the candidate target secondary nodes SN2 and SN3 and check whether the CHO condition is fulfilled by any one of the set of candidate target master nodes MN2, MN3 and MN4. For example, checking whether the CPC condition is fulfilled by a given target SN e.g., SN2 may require that a signal value indicative of a signal received from SN2 exceeds another signal value indicative of a signal received from SN1 by at least a first offset value. Similarly, checking whether the CHO condition is fulfilled by a given target MN e.g., MN2 may require that a signal value indicative of a signal received from MN2 exceeds another signal value indicative of a signal received from MN1 by at least a second offset value.

In case (inquiry step 404) the CPC condition is satisfied e.g., by the candidate target secondary node SN2, before the CHO condition is satisfied, the method then proceeds to step 405 where the user equipment 201 sends a message (CPC message) to the source master node MN1 informing the source master node MN1 that the candidate target secondary node SN2 fulfilled the CPC condition. If the CPC condition is not satisfied before the CHO condition is satisfied, the user equipment 201 may continue checking the CPC condition until the CPC condition is fulfilled.

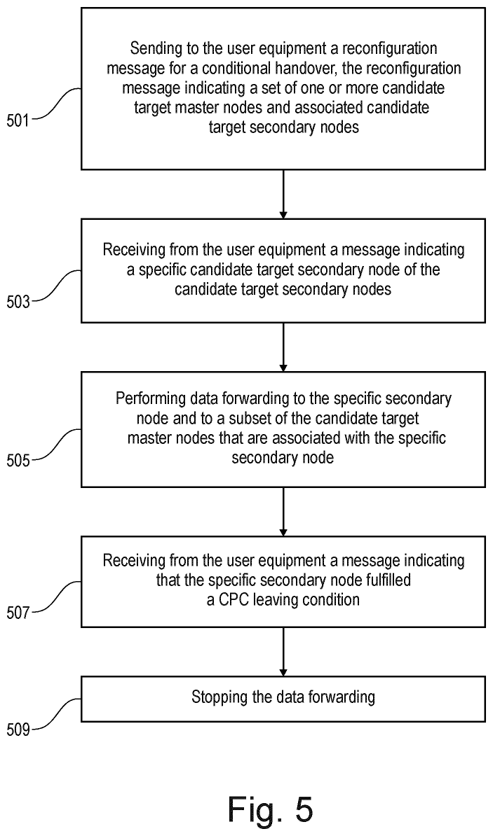

FIG. 5 is a flowchart of a method according to an example of the present subject matter.

For the purpose of explanation, the method described in FIG. 5 may be implemented in the system illustrated in FIG. 2, but is not limited to this implementation. The method may, for example, be performed by the source master node MN1.

The method starts at step 501, where the source master node MN1 may send to the user equipment 201 a reconfiguration message for a conditional handover. The reconfiguration message indicates a set of one or more candidate target master nodes and associated candidate target secondary nodes. Following the example of FIG. 2, the reconfiguration message indicates the set of candidate target master nodes MN2, MN3 and MN4 and the associated candidate target secondary nodes SN2 and SN3.

For example, the source master node MN1 may select the master nodes MN2, MN3 and MN4 as candidate target master nodes for the moving user equipment 201 e.g., because they are neighboring nodes of the source master node MN1. For example, the reconfiguration message may comprise a data structure comprising the following pair entries {MN2, SN2}, {MN2, SN3}, {MN3, SN2} {MN3, SN3} and {MN4, SN3} of the candidate target master nodes and associated candidate target secondary nodes. The reconfiguration message may further comprise a CPC configuration and CHO configuration. The CPC configuration may indicate the CPC condition that may be checked by the UE 201 and the configuration to be applied to a target secondary node that satisfied the CPC condition. The CPC configuration may further indicate the CPC leaving condition. The CHO configuration may indicate the CHO condition that may be checked by the UE 201 and the configuration to be applied to a target master node that satisfies the CHO condition.

In response to the sending of the reconfiguration message, the source master node MN1 may receive in step 503 from the user equipment 201 a message (named CPC message) indicating a candidate target secondary node of the candidate target secondary nodes SN2 and SN3. Assuming, for example, that the candidate target secondary node SN2 is indicated in the CPC message, meaning that the target secondary node SN2 fulfilled the CPC condition.

Upon receiving the CPC message, the method proceeds to step 505, where the source master node MN1 may perform data forwarding to the candidate target secondary node SN2 and to a subset of the candidate primary target nodes that are associated with the candidate target secondary node SN2. For example, the source master node MN1 may select using the received data structure the entries comprising the candidate target secondary node SN2. This may result in the following selected entries: {MN2, SN2} and {MN3, SN2}. The subset of the candidate primary target nodes may thus comprise the master nodes MN2 and MN3 as indicated in the selected entries. The data forwarding performed by the apparatus may concern data that enables to service the user equipment 201.

The source master node MN1 may receive in step 507 from the user equipment 201 a message indicating that the candidate target secondary node SN2 (that previously fulfilled the CPC condition) has fulfilled a CPC leaving condition.

Upon receiving the message, the source master MN1 may stop in step 509 the data forwarding to the candidate target secondary node SN2 and to the subset of the candidate primary target nodes MN2 and MN3 that are associated with the candidate target secondary node SN2.

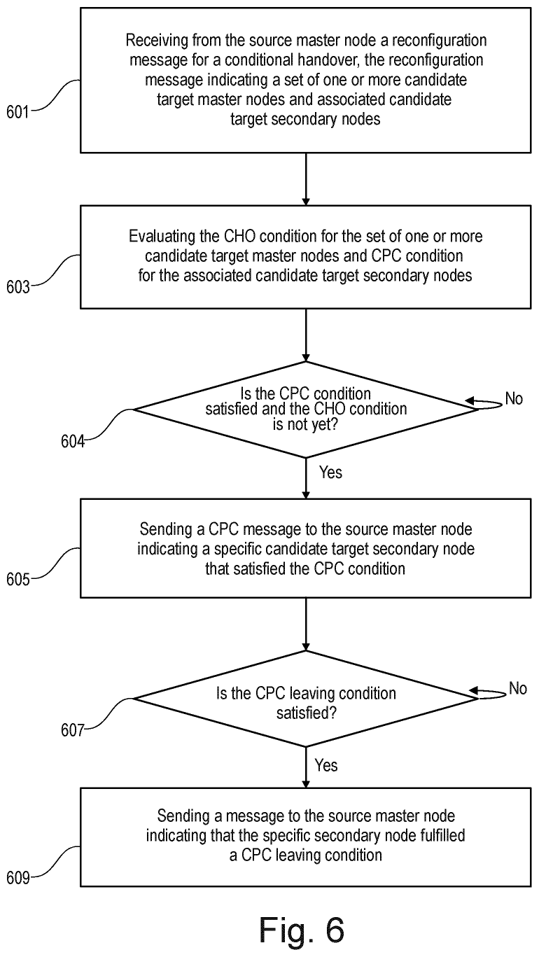

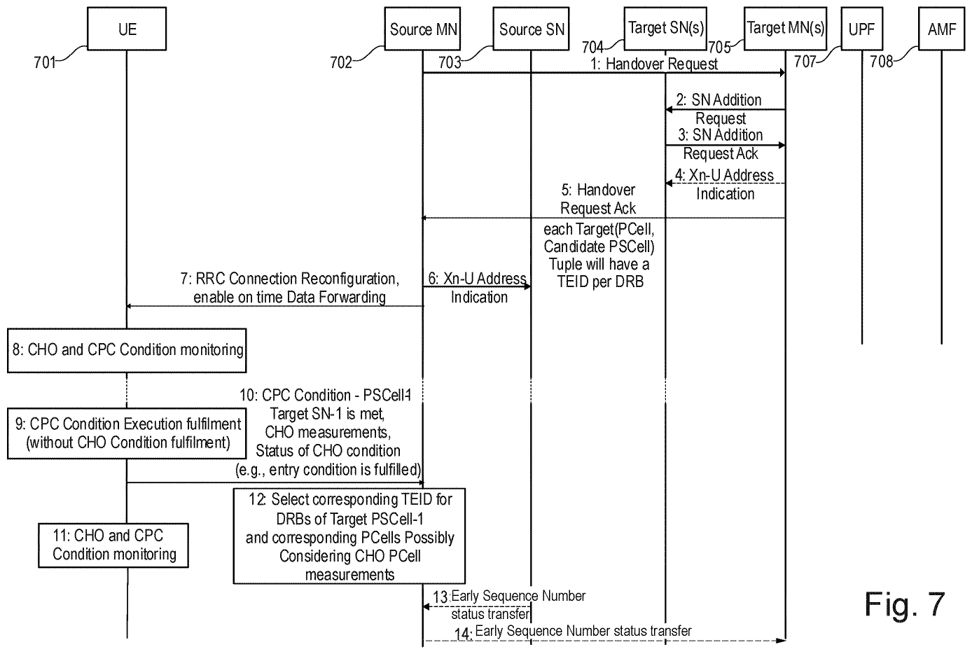

FIG. 6 is a flowchart of a method used in a user equipment according to an example of the present subject matter. For the purpose of explanation, the method described in FIG. 6 may be implemented in the system illustrated in FIG. 2, but is not limited to this implementation. The method may, for example, be performed by the user equipment 201.

The method starts at step 601, where the user equipment 201 may receive from the source master node MN1 a reconfiguration message for a conditional handover. The reconfiguration message indicates a set of one or more candidate target master nodes and associated candidate target secondary nodes. Following the example of FIG. 2, the reconfiguration message indicates the set of candidate target master nodes MN2, MN3 and MN4 and the associated candidate target secondary nodes SN2 and SN3.

For example, the reconfiguration message may comprise a data structure comprising the following pair entries: {MN2, SN2}, {MN2, SN3}, {MN3, SN2} {MN3, SN3} and {MN4, SN3} of the candidate target master nodes and associated candidate target secondary nodes. The reconfiguration message may further comprise a CPC configuration and CHO configuration. The CPC configuration may indicate the CPC condition that may be checked by the UE 201 and the configuration to be applied to a target secondary node that satisfied the CPC condition. The CPC configuration may further indicate the CPC leaving condition. The CHO configuration may indicate the CHO condition that may be checked by the UE 201 and the configuration to be applied to a target master node that satisfied the CHO condition.

Upon receiving the reconfiguration message, the user equipment 201 may check in step 603 the CHO condition and the CPC condition. The user equipment 201 may check whether the CPC condition is fulfilled by any one of the candidate target secondary nodes SN2 and SN3 and check whether the CHO condition is fulfilled by any one of the set of candidate target master nodes MN2, MN3 and MN4. For example, checking whether the CPC condition is fulfilled by a given target SN e.g., SN2 may require that a signal value indicative of a signal received from SN2 exceeds another signal value indicative of a signal received from SN1 by at least a first offset value. Similarly, checking whether the CHO condition is fulfilled by a given target MN e.g., MN2 may require that a signal value indicative of a signal received from MN2 exceeds another signal value indicative of a signal received from MN1 by at least a second offset value.

In case (inquiry step 604) the CPC condition is satisfied e.g., by the candidate target secondary node SN2 before the CHO condition is satisfied, the method then proceeds to step 605, where the user equipment 201 sends a message (CPC message) to the source master node MN1 informing the source master node of the candidate target secondary node SN2 that fulfilled the CPC condition. If the CPC condition is not satisfied before the CHO condition is satisfied, the user equipment 201 may continue checking the CPC condition until the CPC condition is fulfilled.

After the CPC condition is fulfilled, the user equipment 201 may continue monitoring the CPC condition and the CHO condition. Monitoring the CPC condition may comprise checking whether the candidate target secondary node SN2 fulfills a CPC leaving condition e.g., if the CPC condition is not fulfilled anymore by SN2 this indicates that SN2 fulfilled the CPC leaving condition. In case (inquiry step 607) the CPC leaving condition is fulfilled by the candidate target secondary node SN2, the user equipment 201 may send in step 609 to the source master node MN1 a message indicating that the candidate target secondary node SN2 (that previously fulfilled the CPC condition) has fulfilled the CPC leaving condition. If the CPC leaving condition is not satisfied, the user equipment 201 may continue checking the CPC leaving condition until the CPC leaving condition is fulfilled.

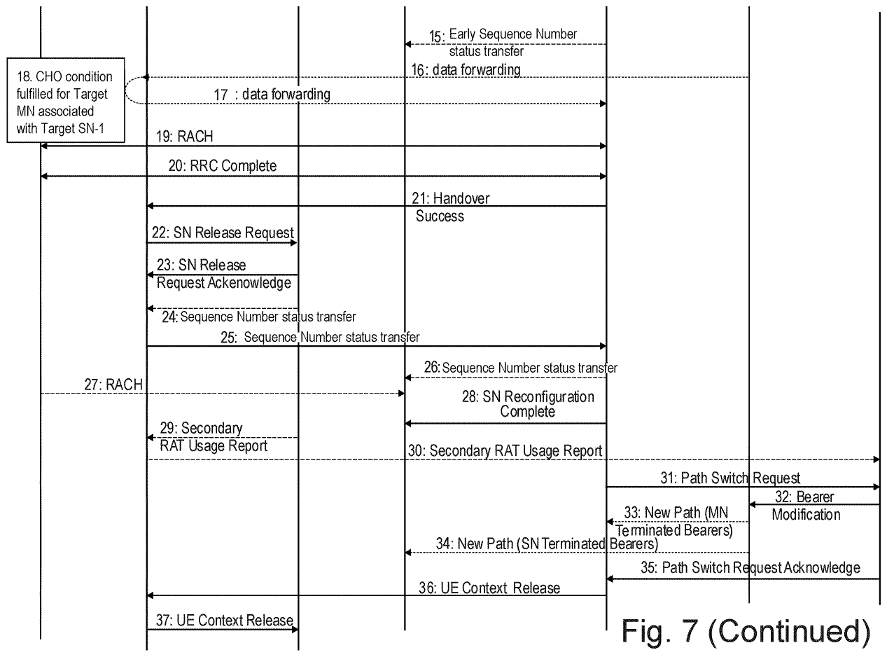

FIG. 7 depicts an example of a signaling diagram between a user equipment 701, a source master node 702, a source secondary node 703, one or more candidate target secondary nodes 704, one or more candidate target master nodes 705, a first core network node 707 (e.g., a user plane function (UPF)), and a second core network node 708 (e.g., access and mobility management function (AMF)), in accordance with an example of the present subject matter. In the example of FIG. 7, the user equipment 701 is first configured with dual connectivity with source master node 702 and source secondary node 703. At 1, the source master node 702 may send a handover request to each of the candidate target master nodes 705. At 2, each of the candidate target master nodes 705 may send a SN Addition Request to a respective candidate target secondary node 704. At 3, each of the candidate target secondary nodes 704 may reply with a SN Addition Request Acknowledge to the respective candidate target master node 705. At 4, each of the candidate target MNs 705 may send to a respective candidate target SN 704 an Xn-U address indication message comprising address information of the interface Xn-U between the candidate target MN 705 and the respective candidate target SN 704. In particular, the Xn-U address indication message may comprise address information of the downlink (DL) transport network layer (TNL). At 5, each of the candidate target MNs 705 may send a Handover Request Acknowledgement message to the source MN 702. The Request Acknowledgement message may comprise a TEID per a direct tunnel (e.g., a DRB tunnel) that may be established by the source MN 702 and the respective candidate target MN 705 or candidate target SN 704 in order to perform the data forwarding. At 6, the source MN 702 may send a XN-U Address Indication message to the source SN 703 to transfer data forwarding information. At 7, the source MN 702 may trigger the UE 701 to perform handover and cell change and apply a configuration. In particular, the source MN 702 may send a RRC connection Reconfiguration message to enable on time data forwarding. At the same time, the source MN 702 may provide at 7 to the UE 701 a flag in order to configure the UE 701 for sending a notification message upon the CPC condition fulfillment. The source MN 702 may also configure the UE 701 to include PCell measurements and CHO condition status (if TTT for CHO condition is running or not, etc.) in the CPC message. At 8, the UE 701 may monitor the CHO condition and CPC condition. The CPC condition may also be referred to as CPAC condition. The UE 701 may check whether the candidate target MNs 705 fulfill the CHO condition and whether the candidate target SNs 704 fulfill the CPC condition. At 9, the CPC condition may be fulfilled by a candidate target SN (named target SN-1) without the CHO condition being fulfilled. The target SN-1 may serve a primary secondary cell PSCell-1. The target SN-1 may only be associated with a subset of the candidate target MNs 705. At 10, the UE 701 may send a message (CPC message) to the source MN 702 indicating that the CPC condition is fulfilled by target SN-1. Optionally, this CPC message may further comprise current CHO measurements and status of CHO condition. At 11, the UE 701 continues checking the CHO condition and CPC condition.

The CHO condition may be checked for each candidate target MN of the candidate target MNs 705. The CPC condition may be checked for each of the candidate target SNs 704. At 12, the source MN 702 may select the subset of candidate target MNs that are associated with the target SN-1. For example, at 12, the source MN 702 may select TEIDs for DRBs of the target PSCell-1 and of corresponding subset of PCells. The subset of PCells may further be reduced by selecting a part of the subset of PCells based the CHO PCell measurements. The source MN 702 may use the selected TEIDs to establish the direct tunnels with the subset of candidate target MNs and with the target SN-1. The source MN 702 may send at 14 the sequence number status to the subset of candidate target MNs 705, including the sequence number status received at 13 from the source SN 703. Each of the subset of candidate target MNs 705 may forward at 15 the sequence number status to the associated candidate target SNs 704.

Data forwarding takes place at 16 and 17. The source MN 702 may perform data forwarding the subset of candidate target MNs 705 and associated candidate target SN-1. At 18, the CHO condition is fulfilled by one candidate target node (named target MN-1) of the subset of candidate target MNs 705.

The UE may perform the RACH procedure at 19 in order to synchronize to the target MN-1, followed by a RRC complete procedure at 20 between the UE 701 and the target MN-1 705. At 21, the target MN-1 705 may send a handover success message to the source MN 702. At 22, the source MN 702 may send a SN release request to the source SN 703. At 23, the source SN 703 may send a SN release request acknowledge to the source MN 702. At 24, the source SN 703 may perform a sequence number status transfer to the source MN 702. At 25, the source MN 702 may perform a sequence number status transfer to the target MN-1 705. At 26, the target MN-1 705 may perform a sequence number status transfer to the target SN-1 704. At 27, the UE 701 may perform the RACH procedure in order to synchronize to the target SN-1 704.

At 28, the target MN-1 705 may send a SN reconfiguration complete message to the target SN-1 704. At 29, the source SN 703 may send a secondary RAT usage report to the source MN 702. At 30, the source MN 702 may send the secondary RAT usage report to the AMF 708. At 31, the target MN-1 705 may send a path switch request to the AMF 708. At 32, the AMF 708 may send a bearer modification request to the UPF 707. At 33, the UPF 707 may send a new path to the target MN-1 705. At 34, the UPF 707 may send a new path to the target SN-1 704. At 35, the AMF 708 may send a path switch request acknowledgement to the target MN-1 705. At 36, the target MN-1 may initiate the UE Context Release procedure towards the source MN 702. Upon reception at 37 of the UE Context Release message from source MN 702, the source SN 703 may release C-plane related resources associated to the UE context towards the source MN 702.

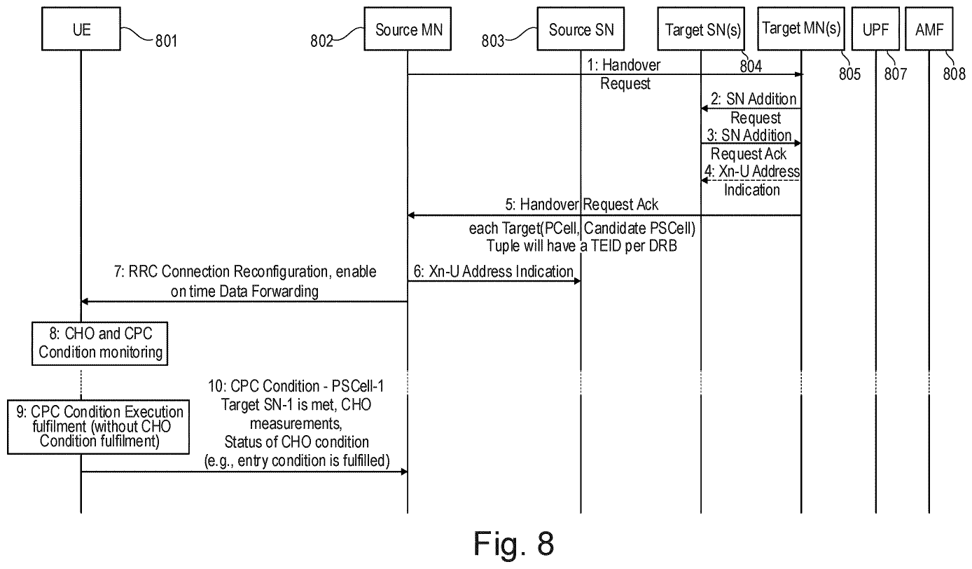

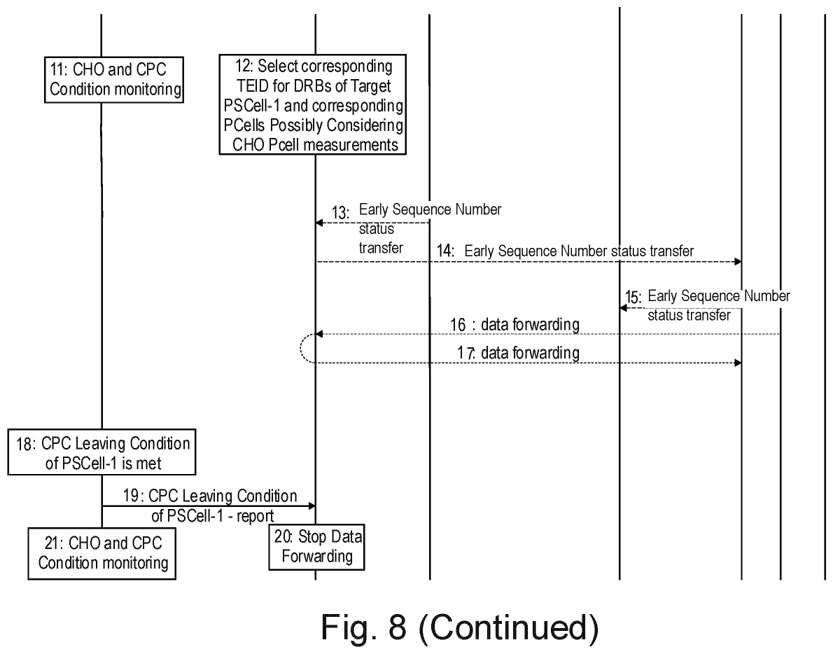

FIG. 8 depicts an example of a signaling diagram between a user equipment 801, a source master node 802, a source secondary node 803, one or more candidate target secondary nodes 804, one or more candidate target master nodes 805, a first core network node 807 (e.g., a user plane function (UPF)), and a second core network node 808 (e.g., access and mobility management (AMF)), in accordance with an example of the present subject matter. In the example of FIG. 8, the user equipment 801 is first configured with dual connectivity with source master node 802 and secondary node 803. At 1, the source master node 802 may send a handover request to each of the candidate target master nodes 805. At 2, each of the candidate target master nodes 805 may send a SN Addition Request to a respective candidate target secondary node 804. At 3, each of the candidate target secondary nodes 804 may reply with a SN Addition Request Acknowledge to the respective candidate target master node 805. At 4, each of the candidate target MNs 805 may send to a respective candidate target SN 804 an Xn-U address indication message comprising address information of the interface Xn-U between the candidate target MN 805 and the respective candidate target SN 804. In particular, the Xn-U address indication message may comprise address information of the downlink (DL) transport network layer (TNL). At 5, each of the candidate target MNs 805 may send a Handover Request Acknowledgement message to the source MN 802. The Request Acknowledgement message may comprise a TEID per a direct tunnel (e.g., a DRB tunnel) that may be established by the source MN 802 and the respective candidate target MN 805 or candidate target SN 804 in order to perform the data forwarding. At 6, the source MN 802 may send a XN-U Address Indication message to the source SN 803 to transfer data forwarding information. At 7, the source MN 802 may trigger the UE 801 to perform handover and cell change and apply a configuration. In particular, the source MN 802 may send a RRC connection Reconfiguration message to enable on time data forwarding. At the same time, the source MN 702 may provide at 7 to the UE 701 a flag in order to configure the UE 701 for sending a notification message upon the CPC condition fulfillment. The source MN 702 may also configure the UE 701 to include PCell measurements and CHO condition status (if TTT for CHO condition is running or not, etc.) in the CPC message. At 8, the UE 801 may monitor the CHO condition and CPC condition. The UE 801 may check whether the candidate target MNs 805 fulfill the CHO condition and whether the candidate target SNs 804 fulfill the CPC condition. At 9, the CPC condition may be fulfilled by a candidate target SN (named target SN-1) without the CHO condition being fulfilled. The target SN-1 may serve a primary secondary cell PSCell-1. The target SN-1 may only be associated with a subset of the candidate target MNs 805. At 10, the UE 801 may send a message to the source MN 802 indicating that the CPC condition is fulfilled by target SN-1. Optionally, this message may further comprise current CHO measurements and status of CHO condition. At 11, the UE 801 continues checking the CHO condition and CPC condition. The CHO condition may be checked for each candidate target MN of the candidate target MNs 805. The CPC condition may be checked for each candidate target SN of the candidate target SNs 804. At 12, the source MN 802 may select the subset of candidate target MNs that are associated with the target SN-1. For example, at 12, the source MN 802 may select TEIDs for DRBs of the target PSCeII-1 and of corresponding subset of PCells. The subset of PCells may further be reduced by selecting a part of the subset of PCells based the CHO PCell measurements. The source MN 802 may use the selected TEIDs to establish the direct tunnels with the subset of candidate target MNs and with the target SN-1. The source MN 802 may send at 14 the sequence number status to the subset of candidate target MNs 805, including the sequence number status received at 13 from the source SN 803. Each of the subset of candidate target MNs 805 may forward at 15 the sequence number status to the associated candidate target SNs 804.

Data forwarding takes place at 16 and 17. The source MN 802 may perform data forwarding the subset of candidate target MNs 805 and associated candidate target SN-1.

At 18, the CPC leaving condition is met. At 19, the UE 801 uses the connection to the source MN 802 to inform it about the fact that the CPC leaving condition is met for target SN-1 804 (or for PSCell-1). At 20, the source MN 802 may stop data forwarding to the respective target MNs 805 and target SN-1. At 21, the UE 801 may perform CHO and CPC condition monitoring. The CPC leaving condition may also be referred to as CPAC leaving condition.

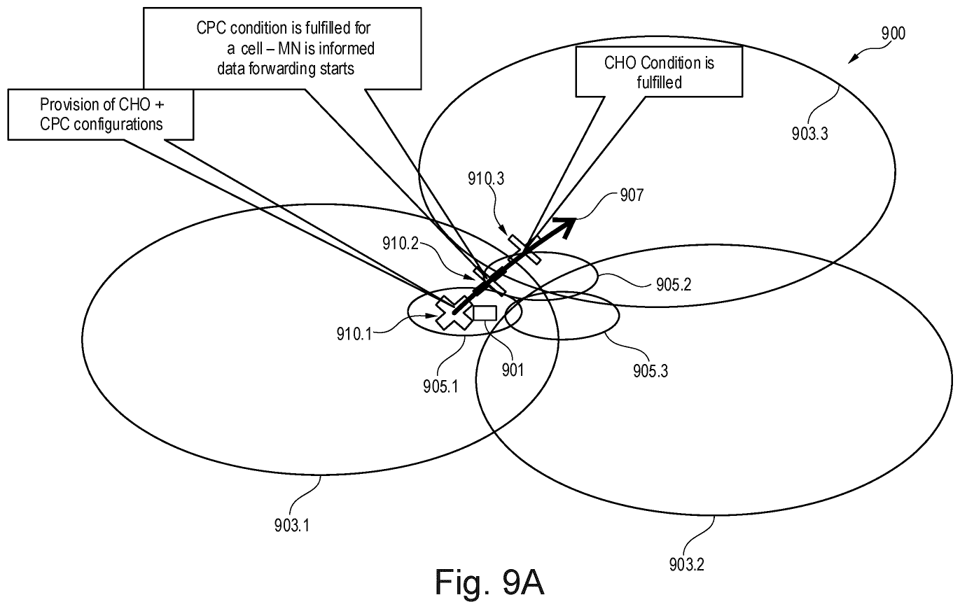

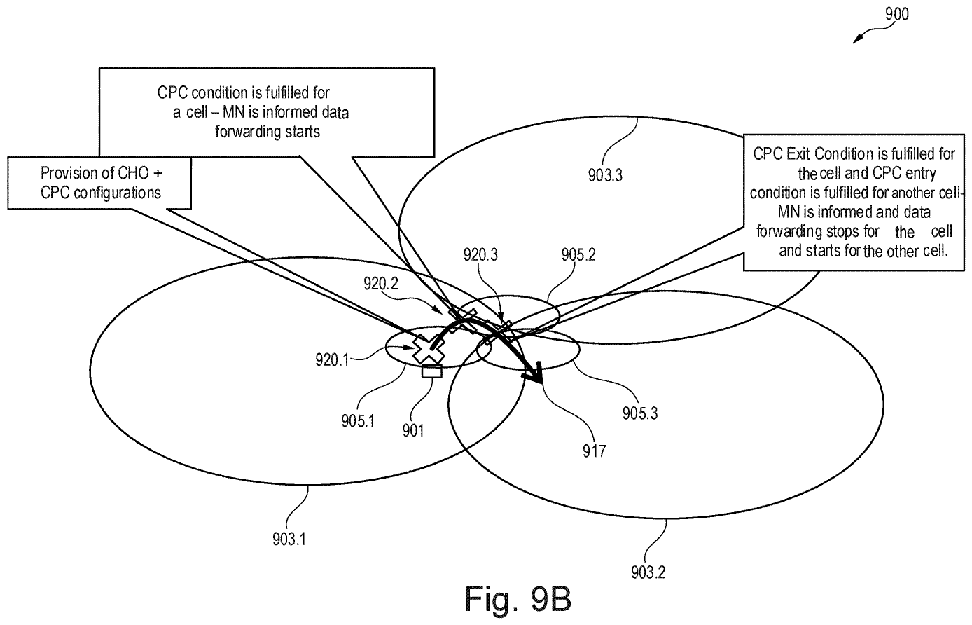

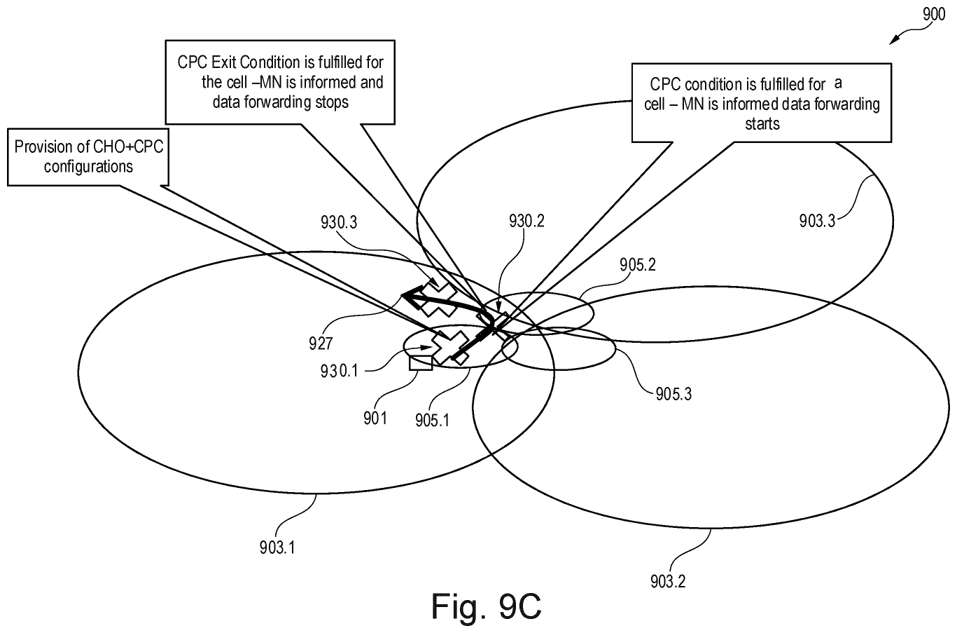

FIG. 9A is a diagram illustrating a process of monitoring the CPC condition and CHO condition by a user equipment in a communication system 900 in accordance with an example of the present subject matter.

In the example of FIG. 9A, the user equipment 901 is first configured with dual connectivity with a source master node and source secondary node (not shown). The user equipment 901 is served by the source master node in the primary cell 903.1. The user equipment 901 is served by the source secondary node in the primary secondary cell 905.1. The communication system 900 further comprises two primary secondary cells 905.2 and 905.3 served by respective secondary nodes and two primary cells 903.2 and 903.3 served by respective master nodes.

In this particular example, the user equipment 901 is moving along the trajectory 907.

FIG. 9A shows three positions 910.1, 910.2 and 910.3 of the user equipment 901 along the trajectory 907. Initially, the user equipment 901 is at position 910.1 where the user equipment 901 receives from the source master node a reconfiguration message indicating the CHO and CPC configurations. While moving, the user equipment 901 may check the CPC condition and the CHO condition. At position 910.2 of the user equipment 901, the CPC condition is fulfilled by the primary secondary cell 905.2. The user equipment 901 may thus inform accordingly the source master node so that the source master node may start the data forwarding to the secondary node serving cell 905.2 and to the two other master nodes because they are both associated with the primary secondary cell 905.2 i.e., their respective served cells 903.2-3 overlap with the primary secondary cell 905.2. While the data forwarding is ongoing and the user equipment 901 is at position 910.3, the CHO condition is fulfilled by the primary cell 903.3, because the user equipment 901 is inside the primary cell 903.3. The user equipment 901 may thus synchronize to the master node serving the primary cell 903.3 and synchronize to the secondary node serving the primary secondary cell 905.2.

FIG. 9B is a diagram illustrating a process of monitoring the CPC and CHO conditions by a user equipment in a communication system 900 in accordance with an example of the present subject matter.

In the example of FIG. 9B, the user equipment 901 is first configured with dual connectivity with a source master node and secondary node (not shown). The user equipment 901 is served by the source master node in the primary cell 903.1. The user equipment 901 is served by the source secondary node in the primary secondary cell 905.1. The communication system 900 further comprises two primary secondary cells 905.2 and 905.3 served by respective secondary nodes and two primary cells 903.2 and 903.3 served by respective master nodes.

In this particular example, the user equipment 901 is moving along the trajectory 917.

FIG. 9B shows three positions 920.1, 920.2 and 920.3 of the user equipment 901 along the trajectory 917. Initially, the user equipment 901 is at position 920.1 where the user equipment 901 receives from the source master node a reconfiguration message indicating the CHO and CPC configurations. While moving, the user equipment 901 may check the CPC condition and the CHO condition. At position 920.2 of the user equipment 901, the CPC condition is fulfilled by the primary secondary cell 905.2. The user equipment 901 may thus inform accordingly the source master node so that the source master node may start the data forwarding to the secondary node serving cell 905.2 and to the two other master nodes because they both are associated with the primary secondary cell 905.2 i.e., their respective served cells 903.2-3 overlap with the primary secondary cell 905.2. However, while the data forwarding is ongoing and the user equipment 901 is at position 920.3, the CPC leaving condition is fulfilled by the primary secondary cell 905.2, because the user equipment 901 is now closer to the primary secondary cell 905.3 which in principle may fulfil the CPC condition when the UE 901 is at position 920.3. The user equipment 901 may thus inform the source mater node accordingly so that the source master node may stop the data forwarding.

FIG. 9C is a diagram illustrating a process of monitoring the CPC and CHO conditions by a user equipment in a communication system 900 in accordance with an example of the present subject matter.

In the example of FIG. 9C, the user equipment 901 is first configured with dual connectivity with a source master node and secondary node (not shown). The user equipment 901 is served by the source master node in the primary cell 903.1. The user equipment 901 is served by the source secondary node in the primary secondary cell 905.1. The communication system 900 further comprises two primary secondary cells 905.2 and 905.3 served by respective secondary nodes and two primary cells 903.2 and 903.3 served by respective mater nodes.

In this particular example, the user equipment 901 is moving along the trajectory 927.

FIG. 9C shows three positions 930.1, 930.2 and 930.3 of the user equipment 901 along the trajectory 907. Initially, the user equipment 901 is at position 930.1 where the user equipment 901 receives from the source master node a reconfiguration message indicating the CHO and CPC configurations. While moving, the user equipment 901 may check the CPC condition and the CHO condition. At position 930.2 of the user equipment 901, the CPC condition is fulfilled by the primary secondary cell 905.2. The user equipment 901 may thus inform accordingly the source master node so that the source master node may start the data forwarding to the secondary node serving cell 905.2 and to the two other master nodes because they both are associated with the primary secondary cell 905.2 i.e., their respective served cells 903.2-3 overlap with the primary secondary cell 905.2. However, while the data forwarding is ongoing and the user equipment 901 moves to position 930.3, the CPC leaving or exit condition is fulfilled by the primary secondary cell 905.2, because the user equipment 901 is now inside the primary cell 903.1. The user equipment 901 may thus inform the source master node accordingly so that the source master node may stop the data forwarding.

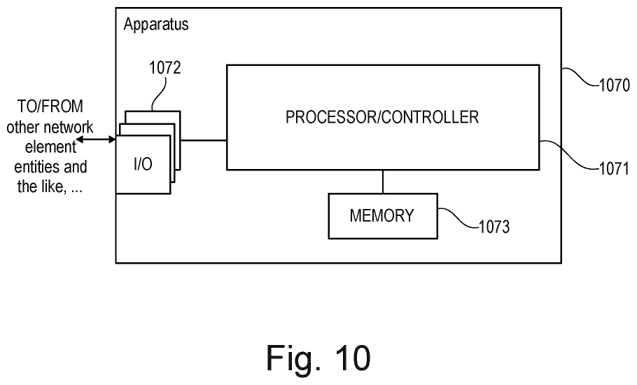

In FIG. 10, a block circuit diagram illustrating a configuration of an apparatus 1070 is shown, which is configured to implement at least part of the present subject matter. It is to be noted that the apparatus 1070 shown in FIG. 10 may comprise several further elements or functions besides those described herein below, which are omitted herein for the sake of simplicity as they are not essential for the understanding. Furthermore, the apparatus may be also another device having a similar function, such as a chipset, a chip, a module etc., which can also be part of an apparatus or attached as a separate element to the apparatus 1070, or the like. The apparatus 1070 may comprise a processing function or processor 1071, such as a central processing unit (CPU) or the like, which executes instructions given by programs or the like related to a flow control mechanism. The processor 1071 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 1072 denotes transceiver or input/output (I/O) units (interfaces) connected to the processor 1071. The I/O units 1072 may be used for communicating with one or more other network elements, entities, terminals or the like.

The I/O units 1072 may be a combined unit comprising communication equipment towards several network elements or may comprise a distributed structure with a plurality of different interfaces for different network elements. Reference sign 1073 denotes a memory usable, for example, for storing data and programs to be executed by the processor 1071 and/or as a working storage of the processor 1071.

The processor 1071 is configured to execute processing related to the above described subject matter. In particular, the apparatus 1070 may be configured to perform the method as described in connection with FIG. 3, 4, 5 or 6.

For example, the processor 1071 is configured for: sending to a user equipment a reconfiguration message for a conditional handover, the reconfiguration message indicating a set of one or more candidate target master nodes and associated candidate target secondary nodes, in response to the sending of the reconfiguration message, receiving by the apparatus from the user equipment a message indicating a specific candidate target secondary node of the candidate target secondary nodes, and performing by the apparatus data forwarding to the specific candidate target secondary node and to a subset of the candidate target master nodes that are associated with the specific candidate target secondary node.

Alternatively, the processor 1071 is configured for: receiving, from an apparatus, a reconfiguration message for a conditional handover, the reconfiguration message indicating a condition, herein referred to as CHO condition, for a conditional handover to a set of candidate target master nodes and another condition, herein referred to as CPC condition, for a conditional Primary secondary cell Change (CPC) to candidate target secondary nodes; evaluating the CHO condition and the CPC condition; in response to determining that the CPC condition is fulfilled by a specific candidate target secondary node candidate target secondary nodes, sending a message to the apparatus indicating the specific candidate target secondary node.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device.

‘Computer memory’ or ‘memory’ is an example of a computer-readable storage medium. Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1-21. (canceled)

22. An apparatus supporting being configured as a master node in order to serve a user equipment in dual connectivity, the apparatus comprising at least one processor; and
at least one memory storing instructions that, when executed by the at least one processor, cause the apparatus at least to:
send to the user equipment a message, herein referred to as reconfiguration message, for a conditional handover, the reconfiguration message indicating a set of one or more candidate target master nodes and associated candidate target secondary nodes;
in response to the sending of the reconfiguration message, receiving from the user equipment a message indicating at least one specific candidate target secondary node of the candidate target secondary nodes;
perform data forwarding to the at least one specific candidate target secondary node and to a subset of the candidate target master nodes that are associated with the at least one specific candidate target secondary node.

23. The apparatus of claim 22, the apparatus being further caused to:
receiving a measurement report from the user equipment;
in response to receiving the measurement report,
evaluating the measurement report and sending a handover request to the set of candidate target master nodes based on the evaluation;
receiving from the set of candidate target master nodes handover request acknowledgements indicating the candidate target secondary nodes;
in response to receiving the handover request acknowledgements performing submission of the reconfiguration message.

24. The apparatus of claim 22, wherein:
while performing the data forwarding, receiving from the user equipment a message indicating that the at least one specific candidate target secondary node fulfils a leaving condition; and in response to receiving the message stopping the data forwarding to the at least one specific candidate target secondary node and to the subset of candidate target master nodes.

25. The apparatus of claim 22, wherein the reconfiguration message indicating a condition for a conditional handover to the set of candidate target master nodes and another condition for a conditional Primary secondary cell Change (CPC) to the candidate target secondary nodes.

26. The apparatus of claim 22, wherein the received message further indicates that the at least one specific candidate target secondary node fulfills a CPC condition as defined in the reconfiguration message.

27. The apparatus of claim 22, wherein the received message comprising cell measurements performed by the user equipment for cells served by the set of the one or more candidate target master nodes, wherein the means are further configured for: selecting the subset of the candidate target master nodes based on the cell measurements.

28. The apparatus of claim 23, wherein the handover request acknowledgments comprise data indicating end points of direct tunnels; the means being configured for using the data for establishing direct tunnels between the apparatus and the at least one specific candidate target secondary node and the subset of the candidate target master nodes for performing the data forwarding using the end points.

29. The apparatus of claim 28, the data comprising Tunnel Endpoint Identifiers (TEIDs) of the direct tunnels.

30. The apparatus of any of claim 23, the apparatus being further caused to receiving a handover success from a specific candidate target master node of the set of candidate target master nodes and in response to the reception of the handover success, stopping the data forwarding to the candidate target nodes which are not the specific candidate target master node.

31. The apparatus of claim 22, wherein the means comprises at least one processor; and at least one memory including computer program code, the at least one memory and the computer program code being configured to, with the at least one processor, cause the performance of the apparatus.

32. A user equipment supporting being in dual connectivity with an apparatus, acting as a source master node, and a source secondary node, the user equipment comprising at least one processor; and
at least one memory storing instructions that, when executed by the at least one processor, cause the user equipment at least to:
receive, from the apparatus, a reconfiguration message for a conditional handover, the reconfiguration message indicating a condition, herein referred to as CHO condition, for a conditional handover, CHO, to a set of candidate target master nodes and another condition, herein referred to as CPC condition, for a conditional Primary secondary cell Change (CPC) to candidate target secondary nodes;
evaluate the CHO condition and the CPC condition;
in response to determining that the CPC condition is fulfilled by at least one specific candidate target secondary node of the candidate target secondary nodes, send a message to the apparatus indicating the at least one specific candidate target secondary node.

33. The user equipment of claim 32, the user equipment being further caused to send the message if the CHO condition is not fulfilled.

34. The user equipment of claim 32, the user equipment being further caused to:
in response to determining that the CHO condition is fulfilled for a specific candidate target master node, synchronize the user equipment to the specific candidate target master node and synchronizing the user equipment to a selected specific candidate target secondary node of the at least one specific candidate target secondary node.

35. The user equipment of any of claim 32, wherein the sent message comprises cell measurements performed by the user equipment for cells served by the set of one or more candidate target master nodes.

36. The user equipment of any of claim 32, the user equipment being further caused to:
determine whether the at least one specific candidate target secondary node fulfills a CPC leaving condition;
in case the CPC leaving condition is fulfilled by the at least one specific candidate target secondary node, send another message to the apparatus indicating that the CPC leaving condition is fulfilled by the at least one specific candidate target secondary node.

37. A method comprising:
sending by an apparatus to a user equipment a message, herein referred to as reconfiguration message, for a conditional handover, the reconfiguration message indicating a set of one or more candidate target master nodes and associated candidate target secondary nodes;
in response to the sending of the reconfiguration message, receiving by the apparatus from the user equipment a message indicating at least one specific candidate target secondary node of the candidate target secondary nodes;
performing by the apparatus data forwarding to the at least one specific candidate target secondary node and to a subset of the candidate target master nodes that are associated with the at least one specific candidate target secondary node.

38. The method of claim 37, the received message comprising cell measurements performed by the user equipment for cells served by the set of the one or more candidate target master nodes, the method further comprising: selecting the subset of the candidate target master nodes based on the cell measurements.

39. A computer program comprising instructions for causing an apparatus for performing at least the following:
sending to a user equipment a message, herein referred to as reconfiguration message, for a conditional handover, the reconfiguration message indicating a set of one or more candidate target master nodes and associated candidate target secondary nodes;
in response to the sending of the reconfiguration message, receiving from the user equipment a message indicating at least one specific candidate target secondary node of the candidate target secondary nodes;
performing data forwarding to the at least one specific candidate target secondary node and to a subset of the candidate target master nodes that are associated with the at least one specific candidate target secondary node.
